(19) United States
(12) Patent Application Publication
(10) Pub. No.: US 2015/0353133 A1
(43) Pub. Date: Dec. 10, 2015

(54) COLLISION AVOIDANCE APPARATUS

(71) Applicant: DENSO CORPORATION, Kariya-city (JP)

(72) Inventor: YASUHIKO MUKAI, Anjo-shi (JP)

(21) Appl. No.: 14/734,097

(22) Filed: Jun. 9, 2015

(30) Foreign Application Priority Data
Jun. 10, 2014 (JP) 2014-119704

(51) Int. Cl. B62D 15/02; B60W 30/09

(52) U.S. Cl. CPC B62D 15/0265; B60W 30/09; B60W 2510/18; B60W 2510/20; B60W 2550/10

(57) ABSTRACT

A collision avoidance apparatus is mounted to an own vehicle and controls the own vehicle to avoid collision with an object that is present ahead of the own vehicle. In the collision avoidance apparatus, when an object ahead is detected, a travelling direction of the own vehicle is changed to avoid collision between the object ahead and the own vehicle if a predetermined first collision avoidance condition is established. The first collision avoidance condition indicates that the own vehicle is in a state in which a travelling direction of the own vehicle is required to be changed. The collision avoidance apparatus determines whether or not a corner is present ahead on a road on which the own vehicle is travelling. When determined that the corner is present, the collision avoidance apparatus is prohibited from changing the travelling direction.

### CROSS-REFERENCE TO RELATED APPLICATION

This application is based on and claims the benefit of priority from Japanese Patent Application No. 2014-119704, filed Jun. 10, 2014, the disclosure of which is incorporated herein in its entirety by reference.

### BACKGROUND

1. Technical Field

The present disclosure relates to a collision avoidance apparatus that controls an own vehicle to avoid collision with an object that is present ahead of the own vehicle.

2. Related Art

A vehicle control apparatus that automatically brakes an own vehicle by controlling the brakes to avoid a collision with an object ahead that is positioned ahead of the own vehicle is conventionally known (refer to, for example, JP-2013-249002).

To avoid a collision between the own vehicle and an object ahead, in addition to stopping the own vehicle by brake control before the own vehicle collides with the object ahead, changing the travelling direction of the own vehicle by steering control is also effective.

However, even if the collision with the object ahead can be avoided as a result of the travelling direction of the own vehicle being changed, the own vehicle runs the risk of veering into an opposing lane.

### SUMMARY

It is thus desired to suppress the occurrence of a situation in which the own vehicle veers into an opposing lane to avoid a collision.

An exemplary embodiment provides a collision avoidance apparatus that is mounted to an own vehicle and which controls the own vehicle to avoid a collision between the own vehicle and an object ahead that is an object present ahead of the travelling own vehicle. The collision avoidance apparatus includes detection means, first collision avoidance means, corner determination means, and first prohibition means.

The detection means detects an object ahead. When the detection means detects an object ahead, the first collision avoidance means changes a travelling direction of the own vehicle to avoid collision between the object ahead and the own vehicle if a predetermined first collision avoidance condition is established. The first collision avoidance condition indicates that the own vehicle is in a state in which a travelling direction of the own vehicle is required to be changed.

The corner determination means determines whether or not a corner is present ahead on a road on which the own vehicle is travelling. When the corner determination means determines that the corner is present, the first prohibition means prohibits the first collision avoidance means from changing the travelling direction.

In the collision avoidance apparatus of the present embodiment configured as described above, when a corner is present ahead on the road on which the own vehicle is travelling, changing of the travelling direction of the own vehicle to avoid collision with an object ahead is prohibited.

The own vehicle tends to more easily veer into an opposing lane as a result of the travelling direction of the vehicle being changed to avoid collision with an object ahead when a corner is present ahead, compared to when a corner is not present ahead. Therefore, in the collision avoidance apparatus of the present disclosure, the occurrence of a situation in which the own vehicle veers into an opposing lane as a result of the travelling direction of the own vehicle being changed to avoid collision can be suppressed.

### BRIEF DESCRIPTION OF THE DRAWINGS

In the accompanying drawings:

FIG. 1 is a block diagram showing a configuration of a collision avoidance apparatus according to an embodiment and apparatuses connected to the collision avoidance apparatus;

FIG. 2 is a flowchart showing a collision avoidance process;

FIG. 3 is a diagram showing a situation in which a bicycle is about to run out in front of a travelling own vehicle;

FIG. 4 is a diagram showing a method for determining an own vehicle collision likelihood;

FIG. 5 is a diagram showing a method for calculating a lateral direction avoidance amount;

FIG. 6 is a diagram showing a method for determining avoidance action;

FIG. 7 is a diagram showing a structure of a corner determination table T1; and

FIG. 8 is a diagram showing a structure of a corner determination table T2.

### DESCRIPTION OF EMBODIMENTS

An embodiment of the present disclosure will hereinafter be described with reference to the drawings.

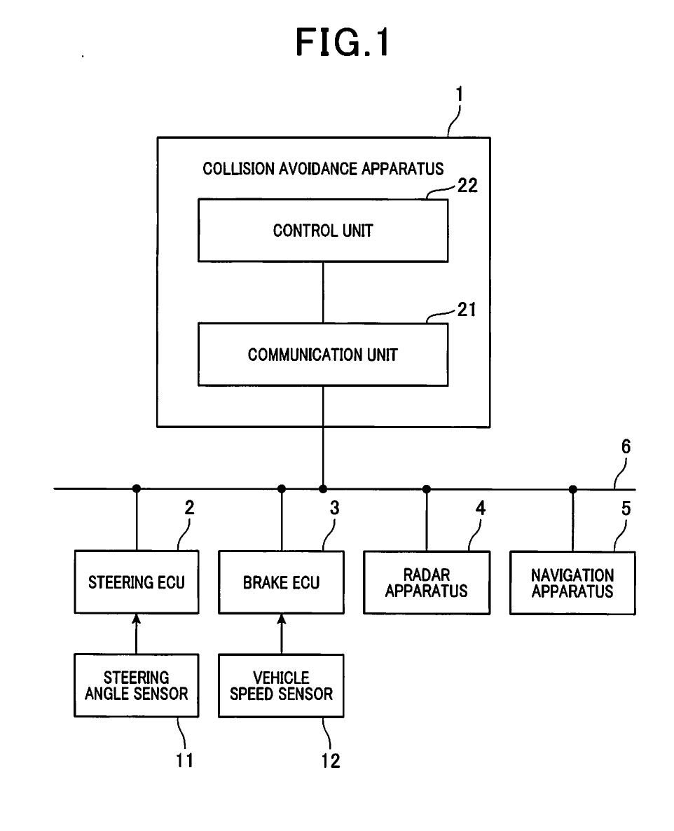

A collision avoidance apparatus 1 according to the present embodiment is mounted in a vehicle and, as shown in FIG. 1, is connected to a steering electronic control unit 2, a brake electronic control unit 3, a radar apparatus 4, and a navigation apparatus 5 by a communication line 6 such as to be capable of data communication with each component. The vehicle to which the collision avoidance apparatus 1 is mounted is referred to, hereafter, as an own vehicle. In addition, the steering electronic control unit 2 is referred to as a steering ECU 2 and the brake electronic control unit 3 is referred to as a brake ECU 3.

The steering ECU 2 performs power steering control in which assistance power is generated when the steering angle of a steering wheel is changed, based on detection signals from a steering angle sensor 11 that detects the steering angle of the front wheels during steering operation by the driver.

In addition, the steering ECU 2 controls the steering angle by driving a steering motor (not shown) that provides steering force to a steering system (e.g., a steering shaft), based on steering control data (such as the change amount of the steering angle) transmitted from the collision avoidance apparatus 1 via the communication line 6.

The brake ECU 3 performs anti-lock braking system (ABS) control, traction control, and the like, based on detection signals from a master cylinder pressure sensor (not shown) that detects a brake operation amount based on the hydraulic pressure in the master cylinder which pumps brake oil, and a vehicle speed sensor 12 that detects the travelling speed of the own vehicle.

In addition, the brake ECU 3 controls braking force by driving a brake actuator (not shown), based on brake control data (such as the deceleration rate) transmitted from the collision avoidance apparatus 1 via the communication line 6.

The radar apparatus 4 transmits radar waves ahead of the own vehicle and receives reflected radar waves, thereby detecting the position of an object present ahead of the own vehicle.

The navigation apparatus 5 acquires map data from a map storage medium in which road map data and various types of information are recorded, and detects the current position of the own vehicle based on global positioning system (GPS) signals received via a GPS antenna (not shown) and the like.

In addition, the navigation apparatus 5 performs control to display the current position of the own vehicle on a display screen, control to provide guidance on a route from the current position to a destination, and the like.

The collision avoidance apparatus 1 includes a communication unit 21 and a control unit 22.

The communication unit 21 transmits and receives data to and from the apparatuses connected to the communication line 6, based on a communication protocol (such as the controller area network (CAN) communication protocol) set in advance.

The control unit 22 is configured mainly by a known microcomputer that is composed of a central processing unit (CPU), a read-only memory (ROM), a random access memory (RAM), an input/output (I/O), a bus line that connects these components, and the like. The control unit 22 performs various processes based on programs stored in the ROM.

In the collision avoidance apparatus 1 configured as described above, the control unit 22 performs a collision avoidance process. The collision avoidance process is repeatedly performed at an execution cycle (such as every 50 ms, according to the present embodiment) set in advance, while the control unit 22 is operating.

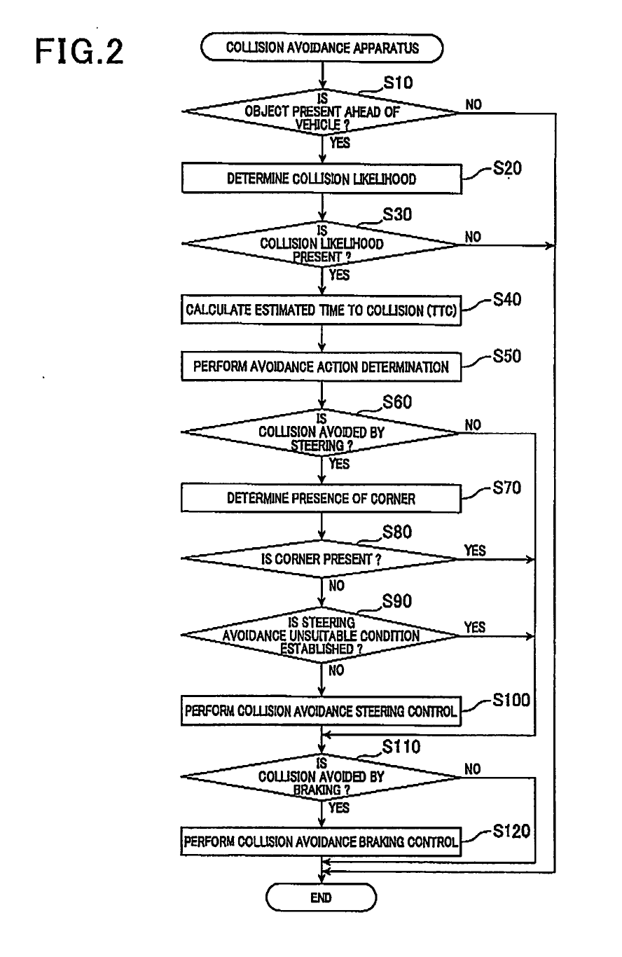

When the collision avoidance process is performed, as shown in FIG. 2, first, at step S10, the control unit 22 determines whether or not an object (referred to, hereafter, as an object ahead) is present ahead of the own vehicle, based on the detection results from the radar apparatus 4.

Here, when determined that an object ahead is not present (NO at step S10), the control unit 22 temporarily terminates the collision avoidance process. Meanwhile, when determined that an object ahead is present (YES at step S10), at step S20, the control unit 22 determines whether or not there is a likelihood of a collision between the object ahead and the own vehicle (referred to, hereafter, as an own vehicle collision likelihood).

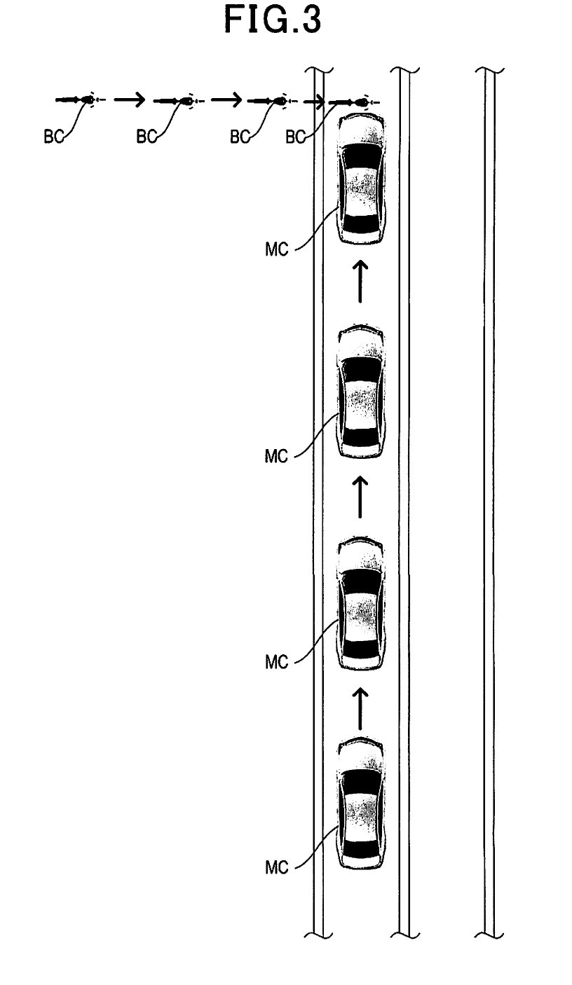

Here, a method by which the control unit 22 determines whether or not there is an own vehicle collision likelihood will be described using, for example, a situation in which a bicycle BC is about to run out in front of a travelling own vehicle MC from the left side of the own vehicle MC, as shown in FIG. 3.

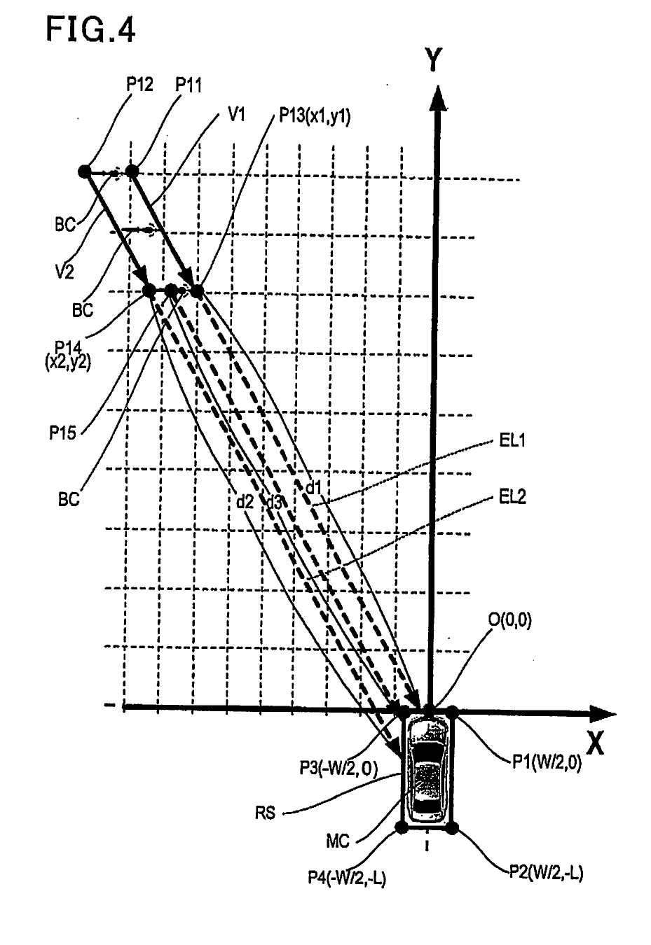

First, as shown in FIG. 4, the control unit 22 sets a two-dimensional orthogonal coordinate system in which the front/back direction of the own vehicle is the Y-axis, the direction perpendicular to the front/back direction of the own vehicle is the X-axis, and the center front-end portion of the own vehicle is the point of origin O (the coordinates being (0,0)).

Here, when the overall width of the own vehicle is W and the overall length of the own vehicle is L, the area in which the own vehicle is present is a rectangle RS of which the vertices are point P1 having the coordinates (W/2,0), point P2 having the coordinates (W/2,−L), point P3 having the coordinates (−W/2,0), and point P4 having the coordinates (−W/2,−L).

The control unit 22 then calculates relative speed vectors at the right end portion and the left end portion of the bicycle BC, based on the detection results from the radar apparatus 4 obtained during the previous collision avoidance process, and the detection results from the radar apparatus 4 obtained during the current collision avoidance process. For example, the positions of the right end portion and the left end portion of the bicycle BC during the previous collision avoidance process are P11 and P12, respectively.

In addition, the positions of the right end portion and the left end portion of the bicycle BC during the current collision avoidance process are P13 and P14, respectively. In this case, a relative speed vector V1 at the right end portion of the bicycle BC is calculated by subtracting the coordinate values of point P11 from the coordinate values of point P13. In a similar manner, a relative speed vector V2 at the left end portion of the bicycle BC is calculated by subtracting the coordinate values of point P12 from the coordinate values of point P14.

Then, when the rectangle RS indicating the area in which the own vehicle is present is positioned on an extension line EL1 of the relative speed vector V1 of which the starting point is point P13 which indicates the current position of the right end portion of the bicycle BC, the control unit 22 determines that there is an own vehicle collision likelihood.

Specifically, first, the control unit 22 calculates the intersection between the extension line EL1 of the relative speed vector V1 of which the starting point is the right end portion of the bicycle BC, and the X-axis.

Here, when the coordinates of the right end portion (point P13) of the bicycle BC are (x1,y1) and the slope of the relative speed vector V1 is a(=dy/dx), the extension line EL1 is expressed by following expression (1).

y=a×(x−x1)+y1 (1)

Therefore, as indicated in following expression (2), the value of x when y=0 in expression (1) is the x-coordinate value of the intersection with the X-axis.

0=a×(x−x1)+y1 (2)

Based on expression (2), the x-coordinate value of the intersection with the X-axis is expressed by following expression (3).

x=−y1/a+x1 (3)

When the x-coordinate value is within a range that is greater than −W/2 and less than +W/2, the control unit 22 determines that there is an own vehicle collision likelihood.

A distance d1 (referred to, hereafter, as a right end portion collision distance d1) between the right end portion (in other words, point P13) of the bicycle BC and the intersection with the own vehicle MC (in other words, the rectangle RS) is expressed by following expression (4).

$$\begin{matrix}d 1 = {\{ y {1}^{2} + {( y 1 / a )}^{2} \}}^{- 1 / 2} \\ = {( 1 + 1 / a )}^{- 1 / 2} \times y 1\end{matrix} \qquad ( 4 )$$

Furthermore, the control unit 22 calculates the intersection between the extension line EL1 of the relative speed vector V1 of which the starting point is the right end portion of the bicycle BC, and the left side of the rectangle RS.

As indicated in following expression (5), the value of y when x=−W/2 in expression (1) is the y-coordinate value of the intersection with the left side of the rectangle RS.

y=a×(−W/2−x1)+y1 (5)

When the y-coordinate value is within a range that is greater than −L and less than 0, the control unit 22 determines that there is an own vehicle collision likelihood.

The right end portion collision distance d1 in this case is expressed by following expression (6).

d1=[(x1+w/2)²+{2×y1+a(w/2−x1)}²]^{-1/2} (6)

Next, the control unit 22 also calculates the intersection with the X-axis and the intersection with the left side of the rectangle RS, of an extension line EL2 of the relative speed vector V2 of which the starting point is the left end portion of the bicycle BC, in a manner similar to those of the extension line EL1, thereby determining the own vehicle collision likelihood. In addition, when determined that there is an own vehicle collision likelihood, the control unit 22 calculates a distance d2 (referred to, hereafter, as a left end portion collision distance d2) between the left end portion (in other words, point P14) of the bicycle BC and the intersection with the own vehicle MC, in a manner similar to that of the extension line EL1.

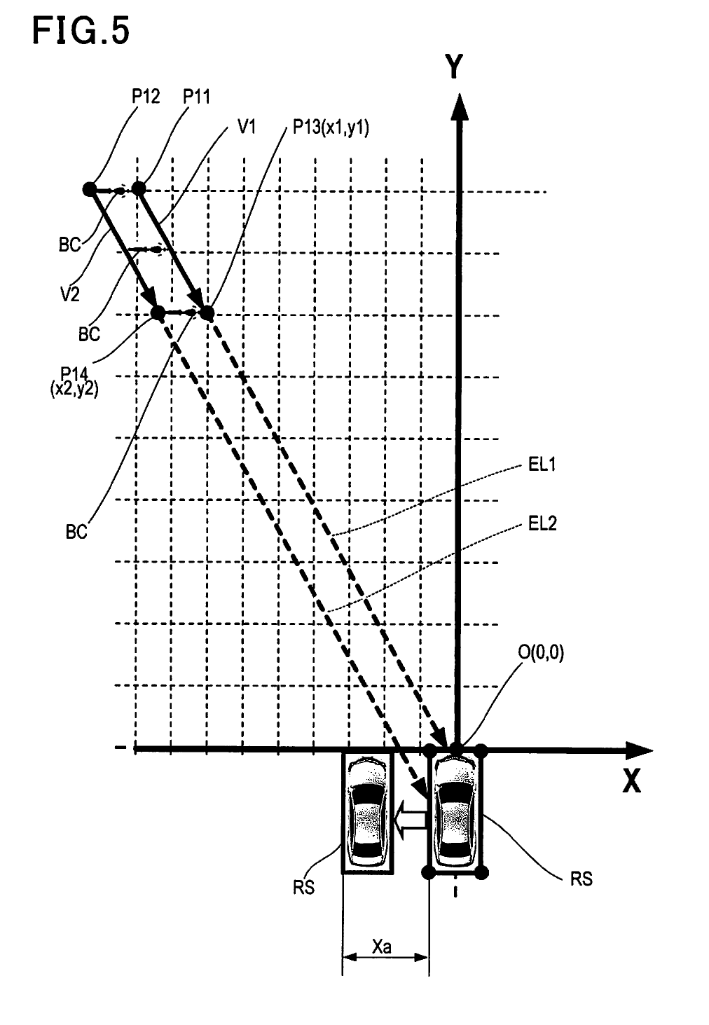

In addition, when determined that there is an own vehicle collision likelihood, as shown in FIG. 5, the control unit 22 calculates a movement amount (referred to, hereafter, as a lateral direction avoidance amount Xa) by which the rectangle RS is moved along the X-axis direction, such that the extension lines EL1 and EL2 do not intersect with the rectangle RS.

Then, after completing the process at step S20, as shown in FIG. 2, at step S30, the control unit 22 determines whether or not there is an own vehicle collision likelihood based on the determination result at step S20. Here, when determined that there is no own vehicle collision likelihood (NO at step S30), the control unit 22 temporarily ends the collision avoidance process. Meanwhile, when determined that there is an own vehicle collision likelihood (YES at step S30), at step S40, the control unit 22 calculates an estimated time to collision TTC.

Here, a method by which the control unit 22 calculates the estimated time to collision will be described using, for example, the situation in which the bicycle BC is about to run out in front of the travelling own vehicle MC from the left side of the own vehicle MC, as shown in FIG. 3.

First, as shown in FIG. 4, the control unit 22 calculates the right end portion collision distance d1, the left end portion collision distance d2, and a center portion collision distance d3. The control unit 22 has already calculated the right end portion collision distance d1 and the left end portion collision distance d2 in the process at step S20. The center portion collision distance d3 refers to the distance (see distance d3 in FIG. 4) between the center portion (see point P15 in FIG. 4) of the bicycle BC and the intersection with the own vehicle MC (in other words, the rectangle RS). At step S40, the control unit 22 calculates the center portion collision distance d3 by a method similar to those for the right end portion collision distance d1 and the left end portion collision distance d2.

Furthermore, the control unit 22 calculates the speed V_{B} of the bicycle BC by following expression (7).

V_{B}={(dx/dt)²+(dy/dt)²}^{-1/2} (7)

Then, the control unit 22 calculates an estimated time to collision TTC1 of the right end portion of the bicycle BC, an estimated time to collision TTC2 of the left end portion of the bicycle BC, and an estimated time to collision TTC3 of the center portion of the bicycle BC by following expressions (8), (9), and (10).

TTC1=d1/V_{B} (8)

TTC2=d2/V_{B} (9)

TTC3=d3/V_{B} (10)

Then the control unit 22 sets the shortest of the estimated times to collision TTC1, TTC2, and TTC3 as the estimated time to collision TTC.

After completing the process at step S40, as shown in FIG. 2, at step S50, the control unit 22 performs determination of avoidance action based on the estimated time to collision TTC and the travelling speed V of the own vehicle (referred to, hereafter, as own vehicle speed V).

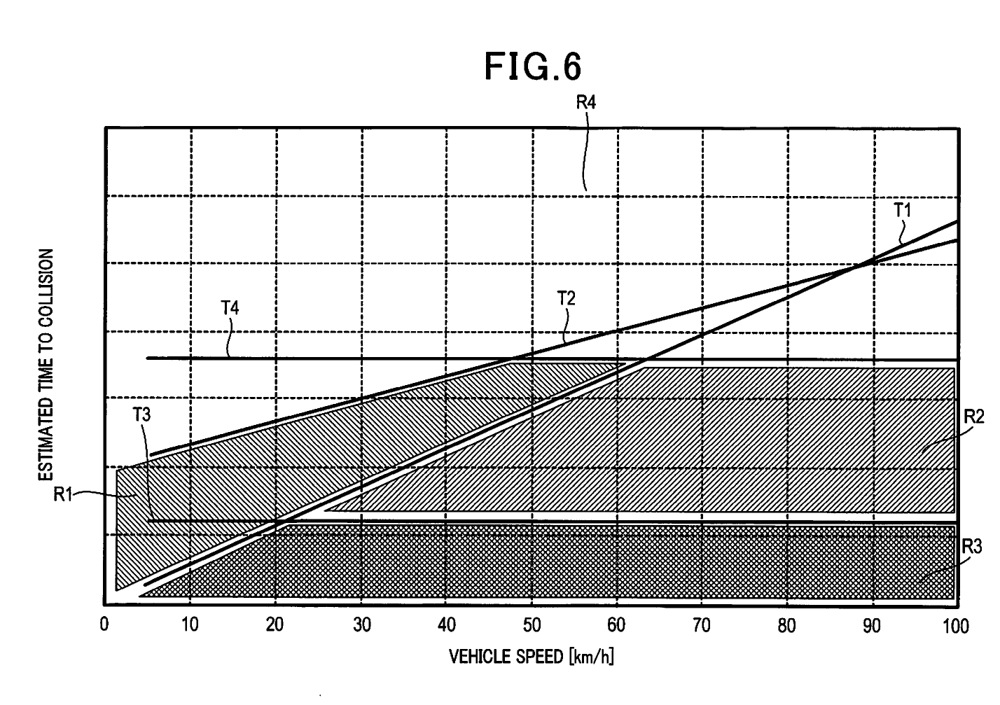

Specifically, as shown in FIG. 6, classification is made into a region R1 (referred to, hereafter, as a braking avoidance region R1) in which a collision is avoided by braking, a region R2 (referred to, hereafter, as a braking/steering avoidance region R2) in which a collision is avoided by steering and braking, a region R3 (referred to, hereafter, as a reduction region R3) in which collision damage is reduced by braking, and a region R4 (referred to, hereafter as an no-assistance region R4) in which avoidance assistance by the collision avoidance apparatus 1 is not performed, based on the estimated time to collision TTC and the own vehicle speed V.

The regions R1, R2, R3, and R4 are decided in advance based on a braking avoidance limit time T1, a normal braking avoidance lower limit time T2, a steering avoidance limit time T3, and a normal steering avoidance lower limit time T4.

The braking avoidance limit time T1 refers the minimum estimated time to collision at which a collision between the own vehicle and the object ahead can be avoided by activating the brakes, and is proportional to the relative speed to the object ahead. In other words, when the driver starts braking operation under a condition in which the estimated time to collision TTC is less than the braking avoidance limit time T1, the collision with the object ahead cannot be avoided by only the braking operation.

The normal braking avoidance lower limit time T2 refers to the minimum estimated time to collision at which the driver of the own vehicle starts the braking operation to avoid collision between the own vehicle and the object ahead, and is proportional to the relative speed to the object ahead.

The steering avoidance limit time T3 refers to the minimum estimated time to collision at which a collision between the own vehicle and the object ahead can be avoided by a steering operation, and is a fixed value independent of the relative speed to the object ahead. In other words, when the driver starts the steering operation under a condition in which the estimated time to collision TTC is less than the steering avoidance limit time T3, the collision with the object ahead cannot be avoided by only the steering operation.

The normal steering avoidance lower limit time T4 refers to the minimum estimated time to collision at which the driver of the own vehicle starts the steering operation to avoid collision between the own vehicle and the object ahead, and is a fixed value independent of the relative speed to the object ahead.

The braking avoidance region R1 is a region that is the braking avoidance limit time T1 or more, less than the normal braking avoidance lower limit time T2, and less than the normal steering avoidance lower limit time T4.

The braking/steering avoidance region R2 is a region that is less than the braking avoidance limit time T1, the steering avoidance limit time T3 or more, and less than the normal steering avoidance lower limit time T4.

The reduction region R3 is a region that is less than the braking avoidance limit time T1 and is less than the steering avoidance limit time T3.

The no-assistance region R4 is regions other than the regions R1, R2, and R3.

Then, at step 50, when determined that the current state of the own vehicle is included in the braking avoidance region R1 or the reduction region R3 based on the estimated time to collision TTC and the own vehicle speed V, the control unit 22 determines that the own vehicle is in a state in which collision is avoided by braking. In addition, when determined that the current state of the own vehicle is included in the braking/steering avoidance region R2, the control unit 22 determines that the own vehicle is in a state in which collision is avoided by braking and steering. Furthermore, when determined that the current state of the own vehicle is included in the no-assistance region R4, the control unit 22 determines that the own vehicle is in a state in which an avoidance action is not taken.

Then, after completing the process at step S50, as shown in FIG. 2, at step S60, the control unit 22 determines whether or not the own vehicle is in a state in which collision can be avoided by steering, based on the determination result at step S50. Here, when determined that the own vehicle is not in a state in which collision can be avoided by steering (NO at step S60), the control unit 22 proceeds to step S110. Meanwhile, when determined that the own vehicle is in a state in which collision can be avoided by steering (YES at step S60), at step S70, the control unit 22 determines whether or not a corner is present in the position at which the own vehicle avoids the object ahead by steering.

Specifically, first, the control unit 22 calculates a distance D [m] over which the own vehicle moves until the own vehicle comes to a complete stop, based on the current own vehicle speed v0 [m/s] and the deceleration rate a0 [m/s²] of the own vehicle when the brakes are operated, by following expression (11).

D=v0×t0−a0×t0²/2 (11)

Furthermore, the control unit 22 acquires road information (curvature of the road, according to the present embodiment) at distance D [m] ahead from the navigation apparatus 5. When determined that the acquired curvature is equal to or greater than a corner determination value set in advance, the control unit 22 determines that a corner is present.

Then, after completing the process at step S70, at step S80, the control unit 22 determines whether or not a corner is present at the position at which the own vehicle avoids the object ahead by steering, based on the determination result at step S70. Here, when determined that the corner is present (YES at step S80), the control unit 22 proceeds to step S110. Meanwhile, when determined that a corner is not present (NO at step S80), at Step S90, the control unit 22 determines whether or not a steering avoidance unsuitable condition that is set in advance is established.

The steering avoidance unsuitable condition is, for example, a residence being present ahead near the road on which the own vehicle is travelling, or the difference in elevation between the road and outside of the road being significant ahead on the road on which the own vehicle is travelling. At step S90, the control unit 22 determines whether or not the steering avoidance unsuitable condition is established using the road map data acquired from the navigation apparatus 5.

Here, when determined that the steering avoidance unsuitable condition is established (YES at step S90), the control unit 22 proceeds to step S110. Meanwhile, when determined that the steering avoidance unsuitable condition is not established (NO at step S90), at step S100, the control unit 22 makes the steering ECU 2 perform collision avoidance steering control to move the own vehicle, by steering, by a lateral direction avoidance amount Xa in the lateral direction at the estimated time to collision TTC to avoid collision, and proceeds to step S110.

Then, after proceeding to step S110, the control unit 22 determines whether or not the own vehicle is in a state in which collision is avoided by braking, based on the determination result at step S50. Here, when determined that the own vehicle is not in a state in which collision is avoided by braking (NO at step S110), the control unit 22 temporarily terminates the collision avoidance process. Meanwhile, when determined that the own vehicle is in a state in which collision is avoided by braking (YES at step S110), at step S120, the control unit 22 makes the brake ECU 3 perform collision avoidance brake control to brake the own vehicle at a deceleration rate set in advance to avoid collision, and then temporarily terminates the collision avoidance process.

In the collision avoidance apparatus 1 configured as described above, first, the radar apparatus 4 detects an object ahead. Then, when the radar apparatus 4 detects an object ahead and the collision avoidance apparatus 1 determines that the own vehicle is in a state in which collision can be avoided by steering, based on the estimated time to collision TTC and the own vehicle speed V (YES at step S60), the collision avoidance apparatus 1 changes the travelling direction of the own vehicle by steering to avoid collision between the object ahead and the own vehicle (step S100).

Furthermore, the collision avoidance apparatus 1 determines whether or not a corner is present ahead on the road on which the own vehicle is travelling (step S70). When determined that a corner is present, the collision avoidance apparatus 1 prohibits change in the travelling direction of the own vehicle by steering (step S80).

In this way, when determined that a corner is present ahead on the road on which the own vehicle is travelling, the collision avoidance apparatus 1 prohibits change in the travelling direction of the own vehicle performed to avoid collision with the object ahead. The own vehicle tends to more easily veer into the opposing lane as a result of the travelling direction of the own vehicle being changed to avoid collision with the object ahead when a corner is present ahead, compared to when a corner is not present ahead. Therefore, the collision avoidance apparatus 1 is able to suppress the occurrence of a situation in which the own vehicle veers into the opposing lane as a result of the travelling direction of the own vehicle being changed to avoid collision.

In addition, when the radar apparatus 4 detects an object ahead and the collision avoidance apparatus 1 determines that the own vehicle is in a state in which collision can be avoided by braking, based on the estimated time to collision TTC and the own vehicle speed V (YES at step S110), the collision avoidance apparatus 1 reduces the travelling speed of the own vehicle to avoid collision between the own vehicle and the object ahead (step S120). As a result, even when change in the travelling direction of the own vehicle is prohibited because a corner is present ahead on the road on which the own vehicle is travelling, the likelihood of a collision with the object ahead being avoided can be increased by the travelling speed of the own vehicle being reduced.

In addition, the collision avoidance apparatus 1 calculates the distance D until the own vehicle comes to a stop, based on the deceleration rate a0 when the travelling speed of the own vehicle is reduced by collision avoidance brake control and the current own vehicle speed v0, and determines whether or not a corner is present at a location that is ahead of the own vehicle by the distance D from the current position of the own vehicle. As a result, the collision avoidance apparatus 1 is able to suppress the occurrence of a situation in which the own vehicle has come to a stop while in a state in which the own vehicle has veered into the opposing lane as a result of the travelling direction of the own vehicle being changed to avoid collision.

In addition, when determined the steering avoidance unsuitable condition that is set in advance to indicate that the state ahead on the road on which the own vehicle is travelling is not suitable for changing the travelling direction of the own vehicle by steering is established, the collision avoidance apparatus 1 prohibits changing of the travelling direction of the own vehicle by steering (step S90). As a result, the collision avoidance apparatus 1 is able to suppress the occurrence of a situation that is not suitable for the own vehicle as a result of the travelling direction of the own vehicle being changed to avoid collision.

According to the above-described embodiment, the radar apparatus 4 is detection means of the present disclosure. The processes at steps S60 and S100 are first collision avoidance means of the present disclosure. The process at step S70 is corner determination means of the present disclosure. The process at step S80 is first prohibition means of the present disclosure.

In addition, the processes at steps S110 and S120 are second collision avoidance means of the present disclosure, and the process at step S90 is second prohibition means of the present disclosure.

An embodiment of the present disclosure is described above. However, the present disclosure is not limited to the above-described embodiment, and various embodiments are possible so long as the embodiments fall within the technical scope of the present disclosure.

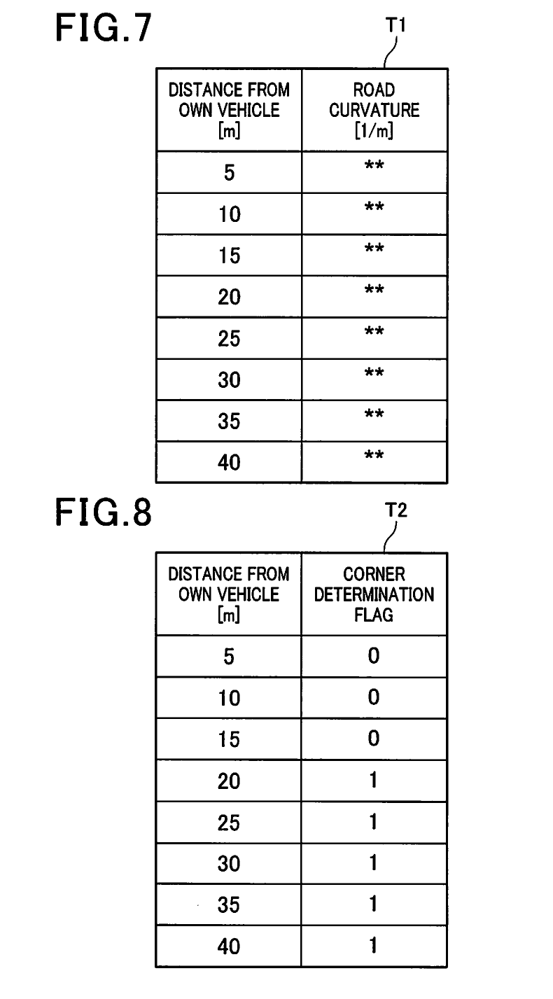

For example, according to the above-described embodiment, after the distance D over which the own vehicle moves until the own vehicle comes to a complete stop is calculated, whether or not a corner is present is determined by the road information of the road distance D [m] ahead being acquired from the navigation apparatus 5. However, as shown in FIG. 7, for example, a corner determination table T1 that indicates the correlation between distance and curvature within a distance range (5 m to 40 m in FIG. 7), set in advance, ahead on the road on which the own vehicle is travelling may be acquired in advance from the navigation apparatus 5, before the distance D is calculated. In other words, after the distance D is calculated, whether or not a corner is present at distance D ahead is determined by the corner determination table T1 being referenced.

As a result, the corner determination information indicating whether or not a corner is present is no longer required to be acquired after the distance D is calculated. The amount of time from when the distance D is calculated until whether or not a corner is present is determined can be shortened. Calculation load can be reduced as the distance interval (5 m in FIG. 7) included in the corner determination table T1 is increased. However, the accuracy of determination of whether or not a corner is present also decreases.

In addition, as shown in FIG. 8, a corner determination table T2 that indicates the correlation between distance and a corner determination flag within a distance range (5 m to 40 m in FIG. 8), set in advance, ahead on the road may be acquired instead of the corner determination table T1. When the corner determination flag is set to 1, a corner is present at the corresponding distance. Conversely, when the corner determination flag is set to 0, a corner is not present at the corresponding distance.

What is claimed is:

1. A collision avoidance apparatus that is mounted to an own vehicle and which controls the own vehicle to avoid collision with an object that is present ahead of the own vehicle, the collision avoidance apparatus comprising:
detection means that detects an object ahead;
first collision avoidance means that when the detection means detects an object ahead, changes a travelling direction of the own vehicle to avoid collision between the object ahead and the own vehicle if a predetermined first collision avoidance condition is established, the first collision avoidance condition indicating that the own vehicle is in a state in which a travelling direction of the own vehicle is required to be changed;
corner determination means that determines whether or not a corner is present ahead on a road on which the own vehicle is travelling; and
first prohibition means that when the corner determination means determines that the corner is present, prohibits the first collision avoidance means from changing the travelling direction.

2. The collision avoidance apparatus according to claim 1, further comprising:
second collision avoidance means that when the detection means detects an object ahead, reduces a travelling speed of the own vehicle to avoid collision between the own vehicle and the object ahead if a predetermined second collision avoidance condition is established, the second collision avoidance condition indicating that the own vehicle is in a state in which the own vehicle is required to be braked.

3. The collision avoidance apparatus according to claim 2, wherein
the corner determination means calculates a stop distance over which the own vehicle moves until the own vehicle stops, based on a vehicle speed of the own vehicle and a deceleration rate of the own vehicle when the own vehicle is braked, and whether or not a corner is present at a position which is apart from a current positon of the own vehicle forward by the stop distance.

4. The collision avoidance apparatus according to claim 3, wherein
before the stop distance is calculated, the corner determination means acquires in advance corner determination information indicating whether or not a corner is present on a road within a predetermined distance range ahead of a road on which the own vehicle is travelling.

5. The collision avoidance apparatus according to claim 1, further comprising:
second prohibition means that prohibits the first collision avoidance means from changing the travelling direction of the own vehicle to avoid collision between the object ahead and the own vehicle if a predetermined prohibiting condition is established, the prohibiting condition indicating that a state ahead on a road on which the own vehicle is travelling is not suitable for changing the travelling direction of the own vehicle.

6. The collision avoidance apparatus according to claim 2, further comprising:
second prohibition means that prohibits the first collision avoidance means from changing the travelling direction of the own vehicle to avoid collision between the object ahead and the own vehicle if a predetermined prohibiting condition is established, the prohibiting condition indicating that a state ahead on a road on which the own vehicle is travelling is not suitable for changing the travelling direction of the own vehicle.

7. The collision avoidance apparatus according to claim 3, further comprising:
second prohibition means that prohibits the first collision avoidance means from changing the travelling direction of the own vehicle to avoid collision between the object ahead and the own vehicle if a predetermined prohibiting condition is established, the prohibiting condition indicating that a state ahead on a road on which the own vehicle is travelling is not suitable for changing the travelling direction of the own vehicle.

8. The collision avoidance apparatus according to claim 4, further comprising:
second prohibition means that prohibits the first collision avoidance means from changing the travelling direction of the own vehicle to avoid collision between the object ahead and the own vehicle if a predetermined prohibiting condition is established, the prohibiting condition indicating that a state ahead on a road on which the own vehicle is travelling is not suitable for changing the travelling direction of the own vehicle.

9. A non-transitory computer-readable storage medium storing a collision avoidance program for enabling a computer to function as a collision avoidance apparatus that is mounted to an own vehicle and which controls the own vehicle to avoid collision with an object that is present ahead of the own vehicle, the collision avoidance apparatus comprising:
detection means that detects an object ahead;
first collision avoidance means that when the detection means detects an object ahead, changes a travelling direction of the own vehicle to avoid collision between the object ahead and the own vehicle if a predetermined first collision avoidance condition is established, the first collision avoidance condition indicating that the own vehicle is in a state in which a travelling direction of the own vehicle is required to be changed;
corner determination means that determines whether or not a corner is present ahead on a road on which the own vehicle is travelling; and
first prohibition means that when the corner determination means determines that the corner is present, prohibits the first collision avoidance means from changing the travelling direction.

10. A collision avoidance method comprising:
detecting an object ahead by detection means;
when the object ahead is detected,
changing, by a collision avoidance apparatus that is mounted to an own vehicle and which controls an own vehicle to avoid collision with an object that is present ahead of the own vehicle, a travelling direction of the own vehicle to avoid collision between the object ahead and the own vehicle if a predetermined first collision avoidance condition is established, the first collision avoidance condition indicating that the own vehicle is in a state in which a travelling direction of the own vehicle is required to be changed;
determining, by the collision avoidance apparatus, whether or not a corner is present ahead on a road on which the own vehicle is travelling; and
when determined that the corner is present,
prohibiting the collision avoidance apparatus from changing the travelling direction.
